(19) United States
(12) Patent Application Publication
(10) Pub. No.: US 2011/0268958 A1
(43) Pub. Date: Nov. 3, 2011

(54) PROCESS FOR FORMING A NON-STICK COATING BASED ON SILICON CARBIDE

(75) Inventors: Jean-Paul Garandet, Grenoble (FR); Beatrice Drevet, Grenoble (FR); Nicolas Eustathopoulos, Grenoble (FR); Emmanuel Flahaut, Puygros (FR); Thomas Pietri, Bourgoin Jallieu (FR)

(73) Assignee: COMMISSARIAT A L'ENERGIE ATOMIQUE ET AUX ENERGIES ALTERNATIVES, Paris (FR)

(21) Appl. No.: 13/062,456

(22) PCT Filed: Sep. 3, 2009
(86) PCT No.: PCT/FR2009/051666

§ 371 Date: May 19, 2011

(30) Foreign Application Priority Data
Sep. 5, 2008 (FR) 0855971

(51) Int. Cl. B05D 3/02; B32B 3/26

(52) U.S. Cl. 428/304.4; 427/387

(57) ABSTRACT

The present invention relates to a process for forming a nonstick coating, said coating being formed from grains of silicon carbide, which are surface-coated with a layer of silicon oxide. It also targets the materials having a coating formed by this process.

The present invention is directed toward proposing a novel type of surface coating for materials, and more particularly crucibles, intended to be brought into contact with liquid materials at high temperature, such as liquid silicon, for the purpose of allowing solidification therein, for example in the form of cylinders.

Photovoltaic cells are predominantly manufactured from mono- or polycrystalline silicon, in dies that involve the solidification of cylinders from a liquid bath. The cylinder is then cut into wafers that serve as the basis for manufacturing cells.

Various techniques have already been described in the literature for preventing adhesion of the solidified material to the crucible.

The technique most commonly used is based on the use of a coating of silicon nitride type on the inner faces of the crucibles that are to come into contact with the molten silicon. The mechanism proposed to explain the detachment is rupture, in the deposition zone, due to the differential expansion stresses between the silicon cylinder and the silica crucible thus surface-treated. Specifically, the mechanical cohesion of the deposit layer is low, since annealing takes place at temperatures that are too low to initiate sintering of the powders.

However, besides its capacity for ensuring detachment, such a coating must satisfy another imperative. It must have sufficient mechanical strength during the phase of contact with the liquid silicon. A coating that has a tendency to flake leads to the dissolution of solid ceramic particles that will be incorporated into the growing silicon, which is unacceptable. Now, the use of silicon nitride powders as a nonstick coating is not entirely satisfactory as regards this second aspect. Buonassisi et al. (1) in particular show that the impurities present in silicon nitride powder may have an adverse impact on the photovoltaic properties of the solidified cylinders. They also mention the presence of silicon nitride particles included in the solidified cylinders, the origin of which may be linked either to the dissolution of nitrogen into the silicon, or to the loosening of nitride grains due to insufficient cohesion of the coating.

Other coating alternatives and/or techniques for producing such coatings have thus been developed in parallel.

For example, patent U.S. Pat. No. 6,491,971 describes a universal technique for applying a wide variety of coatings such as silicon nitride, silicon carbide, zirconium oxide, magnesium or barium zirconate, onto the inner surface of a crucible.

The use of silicon carbide as a coating material may at first sight appear to be an advantageous alternative. Unfortunately, it is not entirely free of drawbacks. Thus, major difficulties during the sawing step are linked to the presence of silicon carbide precipitates in the cylinders. At the scale of the p-n junction of photovoltaic cells, precipitated silicon carbide, on dislocations and other crystallographic defects, acts as a short-circuit and thus limits the performance qualities of the devices (2).

The main object of the invention is, precisely, to propose a process for producing a nonstick coating that does not have the difficulties or limitations outlined above.

Thus, the invention is directed toward proposing a simple and inexpensive coating system for crucibles more particularly intended to be used in the field of manufacturing silicon cylinders or other materials.

One aim of the invention is in particular to propose an economical process for producing a nonstick coating formed from a structure made of silicon carbide and silicon oxide, as defined hereinbelow.

More particularly, the invention relates to a process that is useful for forming a nonstick coating, especially with regard to solid silicon, on the surface of face(s) of a material, comprising at least the steps consisting in:

(1) providing a fluid medium comprising at least one dispersion of silicon carbide grains,
(2) depositing said medium onto the surface of the face(s) of the material to be treated in an amount sufficient to give, on drying of the applied composition, a film formed at least from silicon carbide grains,
(3) exposing the material treated according to step (2) to a heat treatment under an oxidative atmosphere and under conditions sufficient to bring about the formation of a silicon oxide layer at the surface of the silicon carbide grains.

Advantageously, the coating formed according to the present invention comprises at least one porous layer formed from silicon carbide grains that are at least partly coated with a nanometric layer of silica. The porosity may be from 30% to 60% by volume. It may be controlled by the initial composition of the fluid.

According to one preferred embodiment, the composition of step (1) also comprises at least one binder. In this alternative, the dry film obtained after step (2) is formed from silicon carbide grains and said binder, and the heat treatment outlined in step (3) is capable of ensuring the debonding of this film.

According to one embodiment variant, step (2) may be repeated one or more times before performing step (3).

According to another embodiment variant, the process according to the invention as defined above may be reproduced after step (3). In this alternative, the layer formed from silicon carbide grains coated with a nanometric layer of silica is covered with a new thickness of the fluid composition as defined in step (1) and this deposited layer undergoes the consecutive step (3).

The coating formed in the context of the present invention is advantageous in many respects. It simultaneously shows good properties of adhesion to the base material forming the crucible, satisfactory nonstick properties with regard to the cylinder formed by solidification of the liquid silicon poured into this crucible, and good mechanical resistance to liquid silicon.

The porous layer formed from silicon carbide grains may have a thickness ranging from 5 μm to 1 mm and in particular from 10 to 200 μm.

As regards the silica layer, formed at the surface of the silicon carbide grains, it may have a thickness ranging from 2 to 100 nm and especially from 10 to 30 nm.

Other characteristics and advantages of the invention will emerge more clearly from the description that follows. This description corresponds to one particular embodiment of the invention and is given purely as a nonlimiting illustration.

### Silicon Carbide Coating

As emerges from the foregoing, the process according to the invention involves a first step directed toward applying a fluid medium based on silicon carbide grains to the surface of the face(s) of the material to be treated.

The coating derived therefrom has the characteristic of being formed from silicon carbide grains totally or partly coated with silica.

The silicon carbide grains intended to form this coating generally have a particular size and a dispersibility that is suitable to make them compatible with application by spraying according to conventional methods.

Thus, the silicon carbide grains under consideration in the context of the present invention may have a size of less than 5 μm. More particularly, their size ranges from 20 nm to 5 μm and especially from 200 nm to 1 μm.

The amount of silicon carbide grains necessary to obtain the coating is for obvious reasons directly linked to the surface area of the material to be treated. Its assessment clearly falls within the competence of a person skilled in the art.

These grains are maintained in suspension in an inexpensive liquid medium, and more particularly in water.

Besides the silicon carbide grains, this liquid medium may contain an effective amount of at least one organic binder that has chemical and physical properties adequate to facilitate the application of the liquid coating mixture using traditional equipment.

Thus, the organic binder under consideration in the context of the present invention may be chosen from polyvinyl alcohol, polyethylene glycol and carboxymethylcellulose.

For example, the silicon carbide grains/binder(s) mass ratio may be at least 3:1 and more particularly 5:1.

In general, the fluid medium for forming the coating in accordance with the invention combines from 0 to 20% by weight, relative to its total weight, of at least one binder, with 20% to 60% by weight of silicon carbide grains, the associated liquid medium, generally water, forming the remainder to 100%.

The corresponding fluid medium is formed by incorporation of the silicon carbide grains and generally a binder into the liquid medium, generally water, with stirring so as to form a liquid mixture suitable for application to the face(s) to be treated of the material under consideration.

This mixture for forming the coating may, of course, contain other additives intended either for improving its qualities at the time of spraying and/or application, or for giving the corresponding coating related properties.

Such additives may be, for example, dispersants of polycarbonate type, for example carboxylic acid or stearic acid.

The silicon carbide grains, the binder and the solvent under consideration in the context of the present invention have the advantage of leading to coatings on a crucible that are not contaminating for the material to be produced.

### DETAILED DESCRIPTION OF THE PROCESS ACCORDING TO THE INVENTION

The process according to the invention involves a first step directed toward applying a fluid medium based at least on silicon carbide grains onto the surface of the face(s) of the material to be treated.

For the purposes of the present invention, the term “fluid” is intended to denote a deformable state, capable of flowing, and which is thus compatible with application by brush and/or gun, for example.

In the case of an application by gun, the generally liquid fluid medium is transferred from the spray gun at a compressed air pressure and with a nozzle adjusted to obtain the desired coating thickness.

For example, such a gun, equipped with a 0.4 mm nozzle, may be used at a compressed-air pressure of 2.5 bar.

This application of the liquid coating mixture may also be performed via other application modes, for instance by brush, or alternatively by dipping the pieces into a bath.

These application techniques clearly fall within the competence of a person skilled in the art and are not described herein in detail.

The application of the fluid mixture intended to form the coating may be performed at room temperature or at a higher temperature. Thus, the face(s) of the material to be treated according to the invention may be heated so as to be suitable for rapid drying of the applied coating layer.

In this embodiment, at least the face(s) of the material to be treated, or even the entire material, may be heated to a temperature ranging from 25 to 80° C. and especially from 30 to 50° C., thus leading to evaporation of the solvent.

The liquid mixture for forming the coating is applied to the surface of the face(s) to be treated in a suitable thickness to prevent any cracking during drying, for example less than 50 μm.

If necessary, it is possible to make a new application of a layer of the liquid mixture for forming the coating onto a first layer of silicon carbide grains applied and dried, i.e. as formed after step (2).

The process according to the invention also comprises a step of heating under an oxidative atmosphere, to a temperature and within a time that are sufficient to allow the formation of a silicon oxide layer at the surface of the silicon carbide grains, or even the thermal decomposition of the binder, if present.

This step is decisive in several respects.

Firstly, it has the purpose of generating, at the surface of the silicon carbide grains forming the coating, a layer of silicon oxide.

This heat treatment is thus performed under an oxidative atmosphere. It is more particularly air.

It thus also makes it possible, if necessary, to remove the binder, if present. The heat treatment is then performed in a time sufficient to allow total removal of the organic binder.

Advantageously, this thermal step is performed at a temperature below 1095° C.

More particularly, the oxidation step may be performed under an oxidative atmosphere for 1 to 5 hours at a temperature ranging from 500° C. to 1050° C. and more particularly from 800 to 1050° C.

In the context of the present invention, this heat treatment is in fact performed at an adjusted temperature so as not to modify the porosity of the formed coating.

In other words, this temperature remains below the temperature required to obtain sintering of the coating. Furthermore, after this annealing, the coating has a hardness that is sufficient with respect to the mechanical stresses to which it will be subjected, typically less than 50 Shore A.

After this heat treatment, the piece is allowed to cool to room temperature.

A subject of the present invention is also materials having a coating formed via the process as described previously.

The material treated according to the invention is advantageously a crucible. This crucible is generally based on silicon, for instance silica or silicon carbide, but may also be based on graphite.

The invention will now be described by means of the examples that follow, which are given, of course, as nonlimiting illustrations of the invention.

### EXAMPLE 1

A slip, formed from 23% silicon carbide powder, 4% polyvinyl alcohol PVA and 73% water, as mass percentages, is placed in a planetary mill filled with silicon carbide or agate beads to reduce the powder aggregates. The size of the silicon carbide grains formed is between 500 nm and 1 μm.

Since the objective is to reduce only the aggregates, silicon nitride beads may also be envisioned, the risk of pollution with nitrogen being very limited.

The fluid medium thus formed is then sprayed (compressed-air pressure of 2.5 bar, 0.4 mm nozzle placed about 30 cm from the substrate) onto the inner faces of a crucible (of chemical nature) to be coated.

The deposit thus obtained is dried with hot air at a temperature below 50° C.

An undercoat with a thickness of about 50 μm formed from PVA-bound silicon carbide grains is thus obtained.

This spraying and drying procedure is repeated three times to obtain a layer that is then subjected to a stage of 3 hours at 1050° C. under air for binder removal and oxidation of the powders.

Under these conditions, the thickness of the coating finally obtained is about 200 μm, and the thickness of the oxide layer on the silicon carbide grains is about 30 nm.

The coating obtained according to the present invention is very porous.

To prevent the infiltration of silicon into the crucible and to obtain thicker coatings, the procedure for producing a layer (deposition of undercoats with intermediate drying and then high-temperature annealing for binder removal and oxidation of the powders) may be repeated several times.

In general, it is considered that two layers are generally sufficient to obtain the desired nonstick effect.

### EXAMPLE 2

A slip, formed from 52% of prescreened powder, 16% of polyethylene glycol (PEG) and 32% of water, as mass percentages, is placed in a planetary mill equipped with silicon carbide or agate beads to reduce the powder aggregates.

The slip is also subjected to ultrasonication.

The slip is then either deposited by spraying (compressed-air pressure of 2.5 bar, 0.4 mm nozzle placed about 30 cm from the substrate) or using a brush onto the crucible to be coated.

The deposit thus obtained is dried in ambient or warm air (temperature below 50° C.)

An undercoat about 50 μm thick formed from PEG-bound powders is thus obtained. This procedure of spraying (or brushing) and drying is repeated until the desired layer thickness is obtained.

This layer is subjected to a stage of 3 hours at 900° C. under air to remove the binder and to oxidize the powders.

Under these conditions, the thickness of the oxide layer obtained on the silicon carbide grains is about 30 nm.

### EXAMPLE 3

A slip, formed from 57% of prescreened powder and 43% of water, as mass percentages, is placed in a planetary mill equipped with silicon carbide or agate beads to reduce the powder aggregates.

The slip is also subjected to ultrasonication.

The slip is then either deposited by spraying (compressed-air pressure of 2.5 bar, 0.4 mm nozzle placed about 30 cm from the substrate) or using a brush onto the crucible to be coated.

The deposit thus obtained is dried in ambient or warm air (temperature below 50° C.)

An undercoat about 50 μm thick formed from powders bound by Van der Waals forces is thus obtained. This procedure of spraying (or brushing) and drying is repeated until the desired layer thickness is obtained.

This layer is subjected to a stage of 3 hours at 900° C. under air to remove the binder and to oxidize the powders.

Under these conditions, the thickness of the oxide layer obtained on the silicon carbide grains is about 30 nm.

### BIBLIOGRAPHIC REFERENCES

### (1) Buonassisi et al., J. Crystal Growth 287 (2006) 402-407

(2) Bauer et al., Phys. Stat. Sol. (a). 204 (2007) 2190-2195

1. A process for forming a porous, nonstick coating formed from silicon carbide grains at least partly coated with a nanometric layer of silica at the surface of face(s) of a material, comprising:
(1) providing a fluid medium comprising at least one dispersion of silicon carbide grains,
(2) depositing said medium onto the surface of the face(s) of the material to be treated in an amount sufficient to give, on drying of the applied composition, a film formed at least from silicon carbide grains, and
(3) exposing the material treated according to step (2) to a heat treatment under an oxidative atmosphere and under conditions sufficient to bring about the formation of a silicon oxide layer at the surface of the silicon carbide grains and obtain the said porous, nonstick, coating formed from silicon carbide grains.

2. The process as claimed in claim 1, wherein step (2) is repeated one or more times before performing step (3).

3. The process as claimed in claim 1 wherein all of steps (2) and (3) are repeated at least once after step (3).

4. The process as claimed in claim 1, wherein the composition of step (1) also comprises at least one organic binder.

5. The process as claimed in claim 4, wherein the binder is chosen from polyvinyl alcohol, polyethylene glycol and carboxymethylcellulose.

6. The process as claimed in claim 1, wherein the fluid medium included in step (1) is based on water.

7. The process as claimed in claim 1, wherein the fluid medium of step (1) combines from 0 to 20% by weight of at least one binder with 20% to 60% by weight of silicon carbide.

8. The process as claimed in claim 1, wherein step (3) is performed at a temperature below 1095° C.

9. The process as claimed in claim 1, wherein the drying of step (2) is performed at a temperature ranging from 25 to 80° C.

10. The process as claimed in claim 1, wherein step (3) is performed under an oxidative atmosphere for 1 to 5 hours at a temperature ranging from 500° C. to 1050° C.

11. The process as claimed in claim 1, wherein the deposition of step (2) is performed with a brush and/or a gun.

12. The process as claimed in claim 1, in wherein the porous layer formed from silicon carbide grains has a thickness ranging from 5 μm to 1 mm.

13. The process as claimed in claim 1, wherein the silica layer, formed at the surface of the silicon carbide grains, has a thickness ranging from 2 to 100 nm.

14. The process as claimed in claim 1, wherein said material is chosen from silica, silicon carbide and graphite.

15. A material having a porous, nonstick coating formed from silicon carbide grains at least partly coated with a nanometric layer of silica, said coating being formed by a process comprising:
(1) providing a fluid medium comprising at least one dispersion of silicon carbide grains,
(2) depositing said medium onto the surface of the face(s) of the material to be treated in an amount sufficient to give, on drying of the applied composition, a film formed at least from silicon carbide grains, and
(3) exposing the material treated according to step (2) to a heat treatment under an oxidative atmosphere and under conditions sufficient to brim about the formation of a silicon oxide layer at the surface of the silicon carbide grains and obtain the said porous, nonstick, coating formed from silicon carbide grains.

16. The material as claimed in claim 15, wherein it is a crucible.

17. The process as claimed in claim 1, wherein the drying of step (2) is performed at a temperature ranging from 30 to 50° C.

18. The process as claimed in claim 1, wherein step (3) is performed under an oxidative atmosphere for 1 to 5 hours at a temperature ran in from 800 to 1050° C.

19. The process as claimed in claim 1, wherein the porous layer formed from silicon carbide grains has a thickness ranging from 10 μm to 200 μm.

20. The process as claimed in claim 1, wherein the silica layer, formed at the surface of the silicon carbide grains, has a thickness ranging from 10 to 30 μm.
